(19) United States
(12) Patent Application Publication
(10) Pub. No.: US 2009/0151576 A1
(43) Pub. Date: Jun. 18, 2009

(54) HOT PRESS APPARATUS AND A HOT PRESS METHOD FOR THIN PLATE-LIKE WORKPIECES

(75) Inventor: HIDETOSHI ITO, MINOWA (JP)

Correspondence Address: J C PATENTS, INC., 4 VENTURE, SUITE 250, IRVINE, CA, 92618, US

(73) Assignee: MIKADO TECHNOS CO., LTD., NAGANO (JP)

(21) Appl. No.: 12/328,516

(22) Filed: Dec. 4, 2008

(30) Foreign Application Priority Data
Dec. 14, 2007 (JP) 2007-323592

(51) Int. Cl. B30B 15/34

(52) U.S. Cl. 100/305

(57) ABSTRACT

A hot press apparatus for hot pressing a thin plate-like workpiece, includes a base 1, lower and upper heating plates 4, 16, a flat lower mold member 8, lower and upper frame members 10, 18, a workpiece taking-out unit 7, an upper press plate 12, a heat-resistant and stretchable film member 19 covering the lower end portion of the upper frame member 18, a heat medium M filled in a heat medium-filling space above the film member, and a driving unit 13. A film member-horizontally holding member 20 substantially horizontally holds the film member while preventing the film member from hanging, while keeping it at a substantially constant position as viewed in a horizontal direction. The workpiece is hot pressed with the film member by applying pressure to the heat medium inside the heat medium-filling space while the film member is prevented from expanding radially outwardly at an outer periphery thereof.

### INCORPORATION BY REFERENCE

The convention priority of a Japanese patent application No. 2007-323592 filed on Dec. 14, 2007 (now U.S. Pat. No. 4,176,817) is claimed herein, and its entire contents are incorporated herein by reference.

### BACKGROUND OF THE INVENTION

(1)Field of the Invention

The present invention relates to a hot press apparatus and a hot press method for thin plate-like workpieces.

(2) Description of the Related Art

In the press working steps for thin plate-like workpieces, for example, for bonding substrates, they are required to be formed in a uniform thickness at a high precision with a uniform pressure. Meanwhile, the thin plate-like workpieces themselves may be concave-and-convex, wavy or the like, and they are demanded to be plane-pressed under a uniform pressure.

In order to accomplish the above object, a hot press is proposed, which is provided with a thin-film container that is filled with a fluid heat medium and is positioned at a substrate-pressing face of each of upper and lower heating plates so that a uniform bonding plane pressure and uniform transfer of the heat of the heating plates to the substrate may be attained when the substrate is placed between the heating plates (JP-A 1995-195391). By using this hot press, high-precision/uniform thickness forming, correction in bonding for the wavy substrate, etc. are performed in the substrate-bonding process.

### BRIEF SUMMARY OF THE INVENTION

### (1) Object of the Invention

The present invention has been accomplished by obtaining the following knowledge under the following consideration during the development of the present invention. That is, when a film is to be laminated onto a workpiece having a concave-convex shape such as a sealable element-bonded substrate, or when a preliminarily printed thin plate-like sheet is to be embossed, the workpiece needs to be precisely formed without the element or the printed position of the workpiece being deviated from a predetermined pressing position. For this purpose, the workpiece is first located and placed on the upper face of a lower mold member on a fixing jig or a movable type slide table, and a heat medium-pressurizing chamber must be fixed above the workpiece.

On the other hand, in order to form the workpiece in a precise shape, the pressure of the heat medium needs to be effectively transferred to the substrate through the thin film. Thus, the thickness of the thin film is required to be made as thin as possible (for example, around 0.3 mm to 1 mm). The present inventor discovered, however, that when the thickness of thin film is decreased, a central portion of the thin film hangs down in a bell shape by the weight of the heat medium, so that the lower face of the thin film does not uniformly contact the upper face of the substrate and consequently the workpiece may be positionally deviated. Therefore, the present invention is aimed at providing a hot press apparatus and a hot press method, which prevents a thin-film member from hanging down, brings the lower face of the thin-film member onto the upper face of a substrate and as a result causes no positional deviation of a workpiece.

### (2) Measures to Solve the Invention

The hot press apparatus according to the present invention for hot pressing a thin plate-like workpiece comprises:
(1) a base,
(2) a lower heating plate adiabatically placed on an upper face of the base,
(3) a lower mold member arranged on an upper face of the lower heating plate and having a flat and horizontal upper face,
(4) a lower frame member erected on the base and surrounding the lower mold member,
(5) a taking-out unit for taking out the workpiece placed on the upper face of the lower mold member,
(6) supporting poles erected on the base,
(7) an upper press plate fixed at upper portions of the supporting poles,
(8) an upper heating plate adiabatically arranged under a lower face of the upper pressing plate,
(9) an upper frame member arranged on a lower face of the upper heating plate and having a bottom face of a lower end portion thereof to be brought into contact with an upper face of an upper end portion of the lower frame member
(10) a heat-resistant and stretchable film member stretched at and covering the lower end portion of the upper frame member,
(11) a heat medium filled in a heat medium-filling space defined by the upper heating plate, the upper frame member and the heat-resistant and stretchable film member,
(12) a heat medium passage adapted to feed and discharge the heat medium for the heat medium-filling space,
(13) a film member-horizontally holding member adapted to substantially horizontally hold the heat-resistant and stretchable film member while preventing the film member from hanging, said film member-horizontally holding member being fitted to keep the film member at a substantially constant position as viewed in a horizontal direction, and
(14) a driving unit for relatively moving the lower mold member and the upper frame member and bringing the bottom face of the lower end portion of the upper frame member into contact with the upper face of the upper end portion of the lower frame member and spacing the former from the latter,
(15) wherein the bottom face of the lower end portion of the upper frame member is brought into contact with the upper face of the upper end portion of the lower frame member by relatively moving the lower mold member and the upper frame member, the lower face of the heat-resistant and stretchable film member is brought into contact with the upper face of the workpiece on the lower mold member in the state that the heat-resistant and stretchable film member is held substantially horizontally while being prevented from hanging, the workpiece is preheated with the upper and lower heating plates, the workpiece is subjected to a predetermined hot press working with the heat resistant and stretchable film member by applying a pressure to the heat medium inside the heat medium-filling space while the film member being prevented from expanding radially outwardly at an outer periphery thereof.

In the following, preferred embodiments of the hot press apparatus for the thin plate-like workpieces according to the present invention will be recited. Any combinations of the below-mentioned preferred embodiments are also preferred embodiments of the present invention unless any contradiction occurs.
(1) The lower mold member is provided with an upper face-opened depression or a through hole at such a position as not opposed to the film member-horizontally holding member, a depression is formed for the workpiece with the heat-resistant and stretchable film member by applying the pressure to the heat medium.
(2) The film member-horizontally holding member comprises a lower end portion attached to the heat-resistant and stretchable film member, a shaft portion extending upwardly from the lower end portion and an upper end portion upwardly extending from the shaft portion, and the upper portion is held by the upper heating plate.
(3) A spring is provided under a lower end portion of the lower frame member or above an upper end portion of the upper frame member to mitigate an impact when the upper face of the upper end portion of the lower frame member is brought into contact with the bottom face of the lower end portion of the upper frame member.
(4) The film member-horizontally holding member comprises a lower end portion attached to the heat-resistant and stretchable film member, a shaft portion extending upwardly from the lower end portion and an upper end portion extending upwardly from the shaft portion, the shaft portion and/or the upper end portion of the film member-horizontally holding member is horizontally fixed and held in a receiving portion slidably in vertical directions, and a spring is provided under the lower end portion of the lower frame member or above the upper end portion of the upper frame member, so that an impact is mitigated when the upper face of the upper end portion of the lower frame member is brought into contact with the bottom face of the lower end portion of the upper frame member, and the workpiece is subjected to the predetermined hot pressing by further moving the upper frame member in the direction of the lower frame member or the lower frame member in the direction of the upper frame member against the spring in the state that the heat medium passage is closed.
(5) Film member-horizontally holding members are provided in plural rows, the plural film member-horizontally holding members are arranged spaced in each row, lower end portions of the plural membrane horizontal holding members arranged spaced in each of the rows are discontinuous or continuous to form a single row.
(6) the heat-resistant and stretchable film member projects downwardly from the bottom face of the lower end portion of the upper frame member, an inner peripheral face of the lower frame member is slidable around an outer peripheral face of the lower mold member, and when the bottom face of the lower end portion of the upper frame member is brought into contact with the upper face of the upper end portion of the lower frame member by relatively moving the lower mold member and the upper frame member, an outer peripheral face of the heat-resistant and stretchable film member contacts the inner peripheral face of the lower frame member to prevent the film member from expanding radially outwardly.
(7) The lower frame member is placed on the base via a spring, an intermediate moving plate is provided slidably to the supporting poles under the upper press plate, the upper heating plate is adiabatically fixed to a lower face of the intermediate moving plate, a moving cylinder is provided above the upper press plate, and a lower end portion of a cylinder rod of the moving cylinder is fixed to the intermediate moving plate through the upper press plate.
(8) A part of the heat-resistant and stretchable film member is constituted by a protective cover, a lower end portion of the film member-horizontally holding member is attached to the protective cover; the protective cover is held by the film member-horizontally holding member substantially horizontally such that a position where the protective cover is held is substantially constant as viewed in a horizontal direction; when the workpiece is to be hot pressed, the workpiece is protected with the protective cover such that a hot press is not applied to the workpiece directly through the heat-resistant and stretchable film member at a portion of the workpiece corresponding to the protective cover, whereas the workpiece is hot pressed through the heat-resistant and stretchable film member at the other portion.
(9) The workpiece is placed on a substrate having a projected portion at an upper face thereof, and the protective cover is configured to surround the projected portion; when the workpiece is to be hot pressed, a central lower face of the protective cover contacts an upper face of the projected portion through the workpiece, and the workpiece is hot pressed onto the substrate through the protective cover at the upper face of the projected portion and through the heat-resistant and stretchable film member at the other portion.
(10) The protective cover comprises an upper flat portion, a peripheral portion extending downwardly from an outer edge portion thereof, and a press portion at a lower end of the peripheral portion.
(11) A slide table is arranged laterally movably on an upper face of the base, the lower heating plate is arranged on the slide table, the slide table is moved into or out of the hot press apparatus by a slide table-moving unit, so that the lower heating plate, the lower frame member and the lower mold member are moved into or out of the hot press apparatus to take out the hot pressed workpiece, and after a fresh workpiece is fitted onto the lower mold member, the fresh workpiece is arranged inside the hot press apparatus.

The hot press method for hot pressing a thin plate-like workpiece according to the present invention, comprises: (1) placing a thin plate-like workpiece on that upper face of a lower mold member which is flat and horizontal, (2) arranging a heat medium-filling space having a heat-resistant and stretchable film member at a lower face such that a lower face of the heat-resistant and stretchable film member is substantially horizontally held at a substantially constant position as viewed horizontally, while a lower face of the heat-resistant and stretchable film member being prevented from hanging, (3) filling a heat medium inside the heat medium-filling space, (4) bringing the lower face of the heat-resistant and stretchable film member into contact with an upper face of the workpiece on the lower mold member in the state that the heat-resistant and stretchable film member is kept substantially horizontal, while being prevented from hanging down, (5) preheating the workpiece, and (6) subjecting the workpiece to a predetermined hot pressing with the heat-resistant and stretchable film member by applying a pressure to the heat medium inside the heat medium-filled space, while the heat-resistant and stretchable film member is prevented from expanding radially outwardly at an outer peripheral portion thereof.

### EFFECTS OF THE INVENTION

Since the present invention takes the above-mentioned construction, the film member-horizontally holding member is fitted to substantially horizontally hold the heat-resistant and stretchable film member, while preventing the film member from hanging down and to keep substantially constant the position, as viewed in the horizontal direction, where the heat-resistant and stretchable film member is held by the film member-horizontally holding member. Accordingly, the heat-resistant and stretchable film member can be brought into contact with the upper face of the work piece without being positionally deviated. In addition, after the workpiece is preheated, the workpiece is subjected to a predetermined hot processing with the heat-resistant and stretchable film member by applying pressure to the heat medium inside the heat medium-filling space in the state that the heat-resistant and stretchable film member is located and held, while being prevented from expanding radially outwardly at the outer periphery. Thus, the workpiece can be hot pressed precisely under a uniform pressure without the hot pressing position for the workpiece being deviated.

### BRIEF DESCRIPTION OF THE DRAWINGS

FIG. 1 is a perspective view showing a surface-waved multi-layer substrate.

FIG. 2 illustrates a case where a package substrate having a thin element such as a semiconductor, a condenser, a resistor or the like fixed on a thin plate-like substrate at a predetermined position is covered with a protective (sealing) sheet with a thermosetting adhesive.

FIG. 3 is a figure for illustrating a case where a copper sheet and a liquid crystal polyimide are bonded together in the form of a non-adhesive polyimide based flexible copper clad laminate by hot pressing according to the present invention simultaneously with the formation of a groove.

FIG. 4 is a figure for illustrating a case where an element-receiving embossed substrate or a semiconductor-receiving precise package container is produced through the formation of a depression and bonding of a copper sheet and a liquid crystal polyimide to be used as a non-adhesive polyimide based flexible copper clad laminate by hot pressing the copper sheet and the liquid crystal polyimide according to the present invention.

FIG. 5 is an example in which the present invention is used to mold a meter panel for an automobile.

FIG. 6 is a schematic view showing one embodiment of the hot press apparatus according to the present invention.

FIG. 7A is a view for illustrating a hot press operation of one embodiment of the hot press apparatus according to the present invention.

FIG. 7B is a view for illustrating a further hot press operation of one embodiment of the hot press apparatus according to the present invention.

FIG. 7C is a view for illustrating a still further hot press operation of one embodiment of the hot press apparatus according to the present invention.

FIG. 7D is a view for illustrating a still further hot press operation of one embodiment of the hot press apparatus according to the present invention.

FIGS. 8(a) and 8(b) are views for illustrating hot press operations of another embodiment of the hot press apparatus according to the present invention.

FIG. 9A is a sectional view for illustrating a construction to support a heat-resistant and stretchable film member with film member-horizontally holding member and a filmy workpiece W is placed on a surface-curved substrate A fitted in a jig J.

FIG. 9B is a sectional view for illustrating a state in which the heat-resistant and stretchable film member held by the film member-horizontally holding member is brought into contact with the workpiece W on the substrate A and the jig J.

FIG. 9C is a sectional view for illustrating a state in which the filmy workpiece W is bonded onto the curved surface of the substrate A with the film member through applying an oil pressure thereto.

FIG. 9D is a sectional view for illustrating a state in which the workpiece-bonded substrate is taken out from the jig.

FIGS. 10(a) to 10(c) are a perspective view and sectional views, respectively, for illustrating an embodiment in which film member-horizontally holding members are provided in two rows inside a vessel-shaped heat-resistant and stretchable film member, and three film member-horizontally holding members are arranged spaced in each row.

FIG. 11(a) is a perspective view in which film member-horizontally holding members 20 are provided inside a vessel-shaped heat-resistant and stretchable film member 19, and FIG. 11(b) is a sectional view as cut and viewed along a line A-A of FIG. 11(a)″ (See [0062]).

FIG. 12 shows an embodiment in which a film member-horizontally holding member is made of a hard resin or a metal fitting, which is fixed to a film member at its lower end.

FIG. 13 shows an embodiment in which a film member-horizontally holding member is made of a hard resin or a metal fitting, a nut at a lower end portion thereof is insert-molded to a film member and a bolt is screwed into this nut.

FIG. 14 shows an embodiment in which a lower end portion of a spring is insert-molded to a film member, and a lid is fitted by caulking to an upper end portion thereof.

FIGS. 15(a) to (c) are sectional views for schematically showing a still other embodiment of the hot press apparatus according to the present invention in which a protective cover is integrally attached to a central part of a heat-resistant and stretchable film member from an outer side thereof, (a) showing a state in which the hot press apparatus is opened and a workpiece W is held above an element EL on a substrate A, (b) showing a step in which an upper frame member is descended to contact a heat-resistant and stretchable film member with a workpiece W arranged on an element EL and the workpiece is preheated in the state that the upper frame member is temporarily stopped on the way, and (c) showing a step in which the upper frame member is further descended to hot press the workpiece W and cover the upper face of the substrate including the element EL by hot pressing.

FIG. 16 is a sectional view for schematically showing a hot pressed product taken from the hot press apparatus.

FIG. 17 is a sectional view showing a part of another embodiment of the hot press apparatus according to the present invention comprising a heat-resistant and stretchable film member with a protective cover which comprises an upper flat portion, a peripheral portion extending downwardly from the outer peripheral portion of the upper flat portion, and a pressing portion extending radially outwardly from the lower end of the peripheral portion and in which the protective cover is integrally attached to a central portion of the film member from an inner side thereof.

### EXPLANATION OF REFERENCE NUMERALS

1 - - - base, 2 - - - rail, 3 - - - slide table, 4 - - - lower heating plate, 5, 6 - - - soaking plate, 7 - - - air ejecting passage, 8 - - - lower mold member, 8a - - - depression-forming through hole, 9 - - - spring, 10 - - - lower frame member, 11 - - - supporting pole, 12 - - - upper press plate, 13 - - - air cylinder, 14, - - - intermediate movable plate, 15 - - - cylinder rod, 16 - - - upper heating plate, 17 - - - soaking plate, 18 - - - upper frame member, 19 - - - heat-resistant and stretchable film member, 19a - - - reinforcing rib, 20 - - - film member-horizontally holding member, 20a - - - upper end portion, 20b - - - shaft portion, 20c - - - lower end portion, 20d - - - fixing portion, 21 - - - heat medium feeding passage, 30 - - - film-fixing portion, 32 - - - protective cover, 32a - - - upper flat portion, 32b - - - peripheral portion, 32c - - - press portion, A - - - substrate, EL - - - element, J - - - jig, M - - - heat medium, S - - - stopper, SP - - - spring, W - - - workpiece

### BEST MODE FOR CARRYING OUT THE INVENTION

First, in order to facilitate the understanding of the invention, thin plate-like workpieces to which the present invention is applicable will be explained.

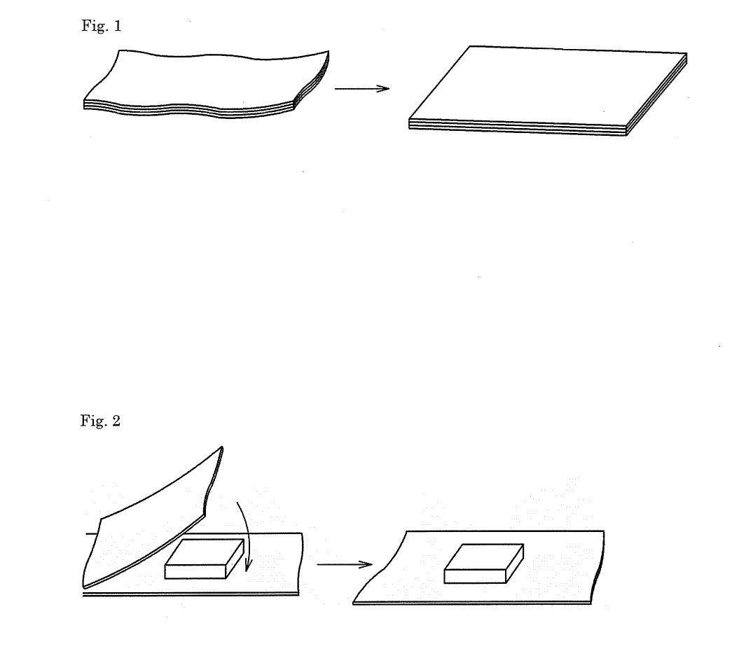

FIG. 1 shows an example of a multi-layer substrate having waved surfaces. It can be converted to a flat-surface multi-layer substrate by applying the present invention thereto without causing a positional deviation. As to this example, a lower mold member having a flat upper face.

FIG. 2 shows an example in which a package substrate having a thin element such as a semiconductor, a condenser, a resistance or the like fixed at a predetermined position of a thin plate-like substrate is covered with a protective sheet having a thermosetting adhesive thereon. Therefore, in this example, the thin plate-like substrate, and the thin element and the protective sheet are regarded as a thin plate-like workpiece as a whole. In this embodiment, the element and the substrate is uniformly covered entirely with the protective sheet without causing the deviation or breakage of the thin element by applying the present invention thereto. As to this example, the lower mold member having the flat upper face is used, too.

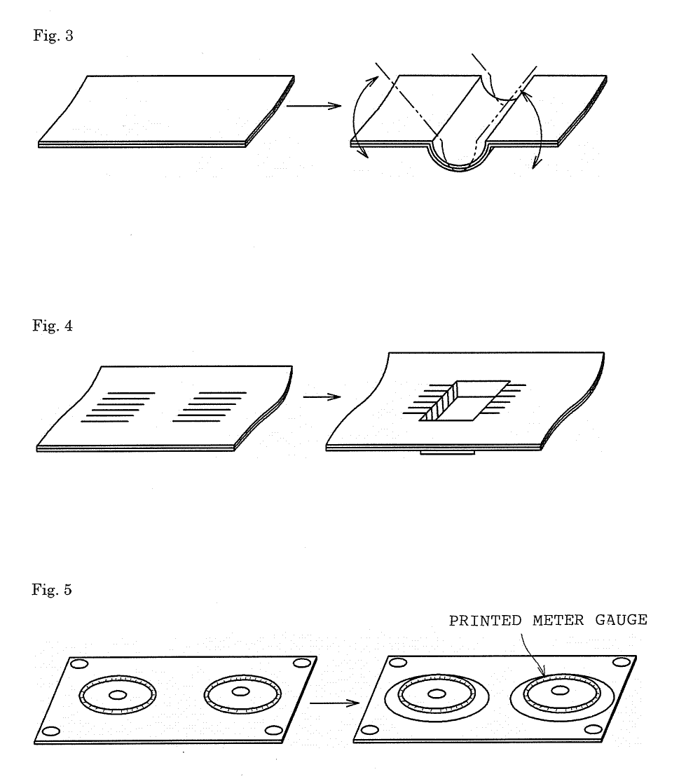

FIG. 3 shows an example in which a groove is formed in a two-layer copper stretched laminate plate having a copper foil on a film made of a liquid crystal polymer such as a polyimide or the like. When a thermosetting polyimide film is used as a substrate, a thermoplastic polyimide of a similar kind is coated or its sheet is laminated on a copper foil, and the thermosetting polyimide film and copper foil are laminated and bonded together through thermally melting and then cooling and curing the thermoplastic polyimide. When the liquid crystal polymer is used as a substrate, the copper foil is bonded to the substrate by thermally melting a lamination boundary surface portion between the liquid crystal polymer and the copper foil. Therefore, when a foldably bendable groove portion is formed in the two-layer flexible copper clad laminate, the laminate is formed in a thermally softened state.

Further, the present invention can be employed for a three-layer copper clad laminate. The three-layer clad laminate is prepared by coating a thermosetting adhesive of a non-polyimide type or laminating its sheet among thermosetting polyimide films and a copper foil. Since this thermosetting time period is longer than the thermally forming time period in the hot pressing, a groove can be formed under a uniform pressure without a positional deviation during a softened state in which two upper and lower adhesive layers are not bonded or set. The present invention can be applied for bonding or groove-forming three-layer or more thin plate-like laminate plates. This example can be applied to the production of bendable printed circuit boards through forming and laminating steps.

FIG. 4 shows an example in which an element-receiving embossed substrate or a semiconductor-receiving precise package container is formed under a uniform pressure without a positional deviation by the hot pressing according to the present invention. In this case, a lower mold member having an upper face-opened depression or a through hole is used.

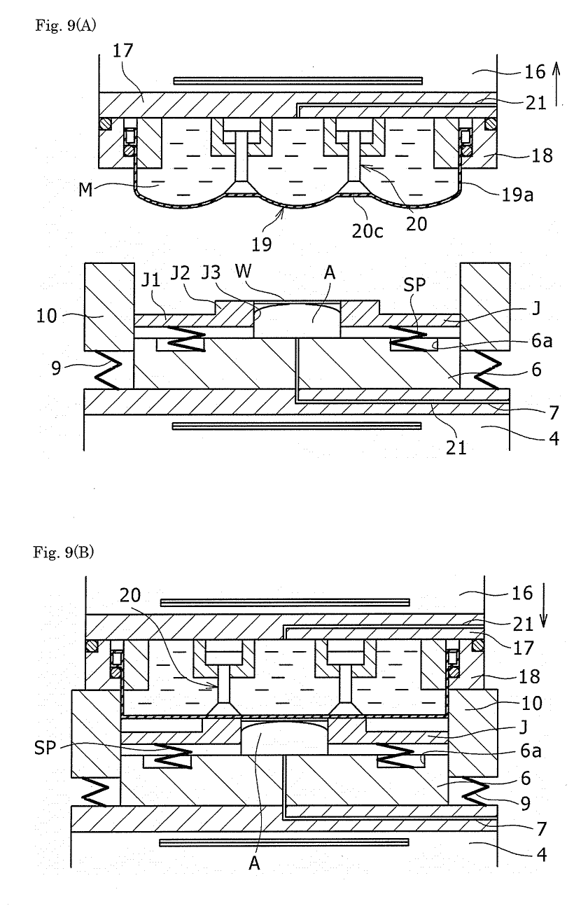

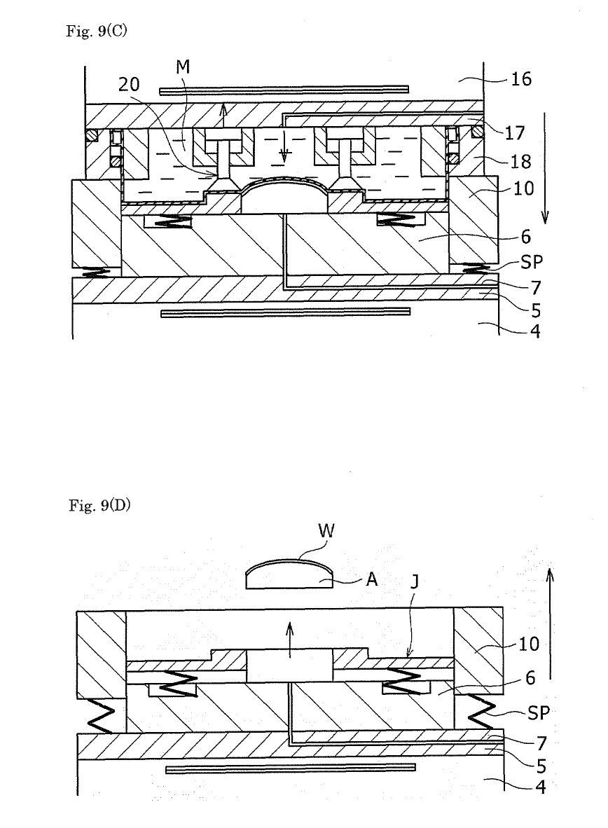

FIG. 5 shows an example in which a meter panel for an automobile is formed by using the present invention. That is, a sheet is first prepared, which has circular meter gauges preliminarily printed on an upper face side-by-side and fitting holes at four corners and is provided with pointer-fitting holes in centers of the meter gauges. The automobile meter panel is obtained by hot pressing the above sheet according to the present invention under a uniform pressure without a positional deviation. As to this example, a lower mold member having an upper face-opened circular groove of a V-letter sectional shape is used. The printed meter gauges are positioned at inner inclined faces of the circular projections, respectively. Further, as shown in FIGS. 9(A) to 9(D) mentioned later, a thin plate-like workpiece such as a flexible printed circuit board, a curvable organic EL panel or a touch panel can be bonded to a molded body having a curved upper face without a positional deviation.

### (1) Base, Lower Heating Plate

A lower heating plate is adiabatically placed on an upper face of a base. In the present invention, posts may be erected on the base so that the lower heating plate can be adiabatically placed on the base via the posts. Further, the lower heating plate may be placed on a heat-insulating plate arranged on the posts. In addition, it is also possible that a slide table mentioned later is placed on the upper face of the base, and the lower heating plate is adiabatically arranged on the slide table. That the lower heating plate is adiabatically placed on the upper face of the base according to the present invention is intended to include all the above embodiments.

### (2) Lower Mold Member

The lower member is to press the workpiece, which is disposed on an upper face of the lower mold member. Although the lower mold member can be disposed directly on the lower heating plate, it can be placed indirectly on the lower heating plate via a soaking plate. That the lower mold member is disposed on the upper face of the lower heating plate according to the present invention involves the cases where it is placed directly or indirectly on the lower heating plate. The soaking plate is to be used for uniformly heat the lower mold member or the workpiece, and the soaking plate can be rapidly cooled by passing a cooling water therethrough. The “flat” of the lower mold member means “substantially flat”, which includes a shape as shown in FIG. 2. As is understood from the explanation of thin plate-like workpieces shown in FIGS. 1 to 5, appropriate lower mold members are used by exchange, depending upon kinds of the workpieces.

### (3) Lower Frame Member

The lower frame member is disposed on the upper face of the base, and surrounds the lower mold member. That the lower mold member is disposed on the upper face of the base according to the present invention involves the cases where it is disposed directly on the upper face of the base and a case where the lower frame member is disposed indirectly on it via the lower heating plate or the heating plate and the soaking plate. In the latter case, since the lower frame member is disposed on the upper face of the base via the lower heating plate or the lower heating plate and the soaking plate, the apparatus can be constructed in a more compact manner. In addition, it can be that a spring or springs are provided under a lower end portion of the lower frame member.

In this case, after the upper frame member is brought into contact with the lower frame member, a descending press operation can be performed, while the heat-resistant and stretchable film member is prevented from spreading radially outwardly at its outer periphery. As mentioned below, the lower frame member can be vertically moved by means of a cylinder mechanism. In that case, a spring or springs can be arranged between the below-mentioned upper heating plate and the upper face of an upper end portion of an upper frame member so that an impact which would occur when the lower frame member is brought into contact with the upper frame member may be mitigated to perform a further ascending pressing operation.

### (4) Workpiece Taking-Out Unit

The workpiece taking-out unit is to peel the hot pressed workpiece from the lower mold member after the workpiece is hot pressed, and comprises an air ejecting passage opened to the upper face of the lower heating plate or the soaking plate so as to eject high pressure air. Alternatively, the workpiece taking-out unit may comprise a pin hole opened to the upper face of the lower heating plate or the soaking plate and a pin inserted through the pin hole so that the hot pressed product may be hit up by the pin. Alternatively, an absorbing unit may be absorbed onto the upper face of the hot pressed product to separate the product away from the lower mold member.

### (5) Supporting Poles, Upper Press Plate, Upper Heating Plate

A plurality of supporting poles is erected on the base, and an upper press plate is fixed to upper portions of the supporting poles. An upper heating plate is adiabatically arranged under the lower face of the upper press plate. The upper heating plate may be adiabatically arranged under the lower face of the upper press plate by connecting the upper press plate with the upper heating plate by posts. The upper press plate and the upper heating plate may be connected by the posts via an adiabatic plate arranged on the ends of the posts. In that case, hot pressing is performed by vertically moving the lower mold member. Alternatively, it can be that an intermediate movable plate is slidably provided relative to the supporting poles under the upper press plate, and the intermediate movable plate and upper heating plate are adiabatically connected by means of the posts. In this case, hot pressing is performed by vertically moving the intermediate movable plate.

### (6) Upper Frame Member, Heat-Resistant and Stretchable Film Member, Protective Cover, Heat Medium, Openable/Closable Heat Medium Passage

### (6-1) Upper Frame Member

The upper frame member is attached to a lower face of the upper heating plate directly or indirectly via a soaking plate. That the upper frame member is arranged at the lower face of the upper heating plate according to the present invention includes a case where the upper frame member is directly or indirectly arranged under the lower face of the upper heating plate as mentioned above.

### (6-2) Heat-Resistant and Stretchable Film Member

The heat-resistant and stretchable film member is made of a heat-resistant and stretchable material, and it may be stretched to be almost in flush with an opening at the lower end of the upper frame member, or it may be stretched, projecting downwardly from the opening at the lower end of the upper frame member. In the former case, when the heat medium is pressurized in the below-mentioned heat filling space, the heat-resistant and stretchable film member can be prevented from expanding radially outwardly at an outer periphery thereof. On the other hand, in the latter case, the heat-resistant and stretchable film member is constructed such that an outer peripheral face of the film member is made of a reinforcing member, and when the upper frame member is brought into contact with the lower frame member, the outer peripheral face of the reinforcing member contacts the inner peripheral face of the lower frame member; and when the heat medium inside the heat medium-filling space is pressurized, the heat-resistant and stretchable film member is prevented from expanding radially outwardly at the outer periphery.

And, as the heat-resistant and stretchable film member at such a portion as for press forming, a heat-resistant elastic silicone rubber, a heat-resistant elastic fluorine rubber or the like can be recited by way of example. Its thickness can be 0.3 to 1 mm, for example, from the standpoint of uniform and precise press working according to the present invention. Furthermore, the pressure applied to the heat medium inside the heat medium-filling space may be a level enough to perform a required press working. For example, it can be 1 to 10 MPa.

### (6-3) Protective Cover

A part of the heat-resistant and stretchable film member is constituted by a protective cover, and the lower end of the film member-horizontally holding member is attached to the protective cover so that the film member-horizontally holding member may substantially horizontally hold the protective cover such that the position where the former holds the latter is almost kept constant as viewed in a horizontal direction. The heat-resistant and stretchable film member is liquid-tightly connected to the outer periphery of the protective cover. For this purpose, the protective cover can be integrally attached to the heat-resistant and stretchable film member from an inner side or an outer side thereof by integral forming or bonding. Alternatively, it may be that the heat-resistant and stretchable film member is designed in an annular shape and the inner annular edge portion of the film member is fixedly and liquid-tightly attached to the peripheral portion of the protective cover.

When the workpiece is to be hot pressed, a hot press pressure is not be applied thereto directly through the heat-resistant and stretchable film member because that portion of the workpiece which corresponds to the protective cover is covered with the protective cover, whereas the other portion of the workpiece is hot pressed through the heat-resistant and stretchable film member. This embodiment may be applied to (1) a case where a workpiece has that portion corresponding to the protective cover which needs to be so protected because of brittleness or the like that a hot press pressure may not be applied thereto via the heat-resistant and stretchable film member, (2) a case where a thin workpiece is hot pressed and bonded onto a substrate having an upper face-flat and projected portion at its upper face, and (3) a case where a thin workpiece is hot pressed and bonded onto upper faces of a substrate and an upper face-flat element placed on the substrate.

In the present invention, “the substrate having the upper face-flat projected portion” includes the case where a fragile element, such a semiconductor element, having a projected flat upper face, is placed on the substrate and the upper faces of the substrate and the element exhibits a projected upper face as a whole. The protective cover is configured to surround such a projected portion, and the workpiece is positioned on the upper face of the projection of the sheet-like workpiece. When the hot press is to be performed, a lower face of the protective cover is brought into contact with the projection of the substrate via the workpiece, a portion of the workpiece on the projection of the substrate is hot pressed onto the upper face of the projection via the protective cover, whereas the workpiece is hot pressed substantially onto a portion the upper face of the substrate other than that portion. This embodiment can be used to seal the element such as the semiconductor element on the substrate with the thin workpiece.

When the workpiece has a flat upper face, the protective cover is in a flat-plate shape so that portion of the workpiece which faces the protective cover is so protected with the protective cover that the hot press pressure may not be applied to thereto directly through the heat-resistant and stretchable film member, whereas the other portion of the thin-plate like workpiece is hot pressed through the heat-resistant and stretchable film member.

When the substrate having the upper face-flat projection on the upper face thereof is to be hot pressed, the protective cover is constituted by an upper flat face portion, a peripheral portion extending downwardly from an outer periphery thereof and a press portion at the lower end of the peripheral portion so that when the workpiece is pressed onto the substrate through the press portion, the projection may be surrounded by the upper flat face portion, the peripheral portion and the press portion and the lower face of the upper flat face portion of the surrounding protective cover may contact the upper flat face of the projection. When the hot press is performed, the central lower face of the protective cover contacts the upper flat face of the projection through the workpiece, and the workpiece is hot pressed onto the upper face of the projection through the protective cover and substantially onto the upper face of the substrate through the heat-resistant and stretchable film member excluding the projection.

The flat shape of the protective cover as viewed downwardly from the above may be appropriately selected from a round shape, a rectangular or square shape, etc. depending upon the use. The material and thickness of the protective cover may be selectively determined to give rigidity enough to be held horizontally. A metal, a heat-resistant hard resin or the like can be used for the protective cover.

### (6-4) Heat Medium

The heat medium is filled in the heat medium-filling space defined by the upper heating plate, the upper frame member and the heat-resistant and stretchable film member. Here, when the upper frame member is attached to the upper heating plate via the soaking plate, strictly speaking, that the heat medium is filled in the heat medium-filling space defined by the soaking plate under the upper heating plate, the upper frame member and the heat-resistant and stretchable film member. For the simplicity, according to the present invention, the latter case is involved in the case where the heat medium is filled in the heat medium-filling space defined by the upper heating plate, the upper frame member and the heat-resistant and stretchable film member. Further, an openable/closable heat medium passage, which feeds and discharges the heat medium for the heat medium-filling space, is provided in the upper heating plate or the soaking plate. As the heat medium, oil of the like are recited.

### (7) Film Member-Horizontally Holding Member

The film member-horizontally holding member is to prevent the heat-resistant and stretchable film member from hanging down and to substantially horizontally hold the film member. The film member-horizontally holding member is attached such that the position where the heat-resistant and stretchable film member is held by the film member-horizontally holding member is kept almost constant as viewed in the horizontal direction. When the heat-resistant and stretchable film member is supported at the outer periphery, it hangs down due to the weight of the heat medium. That the heat-resistant and stretchable film member is substantially horizontally held while being prevented from hanging down means that when the heat-resistant and stretchable film member is supported by the film member-horizontally holding member, the hanging down degree is totally so small, although partially hangs down, so that the holding member holds the film member sufficiently enough to attain the effects of the present invention.

In addition, when the film member-horizontally holding member substantially horizontally holds the heat-resistant and stretchable film member while preventing it from hanging down, the former holds the latter at the constant position as viewed horizontally. Consequently, when the heat-resistant and stretchable film member is brought into contact with the thin plate-like workpiece placed on the flat and horizontal lower mold member, the film member is located without being positionally deviated. When the heat-resistant and stretchable film member contacts the upper face of the workpiece, the lower end portion of the film member-horizontally holding member may contact the upper face of the workpiece directly or indirectly via the heat-resistant and stretchable film member.

Although the film member-horizontally holding member upwardly suspends the heat-resistant and stretchable film member such that the lower face of the film member is horizontal, the film member can be suspended relative to the upper heating plate or the soaking plate, for example. Meanwhile, the film member-horizontally holding member is attached to the heat-resistant and stretchable film member at such a position as not hindering the press working.

Furthermore, a plurality of the film member-horizontally holding members can be provided in plural rows, while the plural film member-horizontally holding members are arranged spaced from each other in each row. The lower end portions of the plural film member-horizontally holding members arranged spaced in each row may be discontinuous at a required interval or continued to form a single row. The film member-horizontally holding member may comprise a lower end portion attached to the heat-resistant and stretchable film member, a shaft portion extending upwardly from the lower end portion, an upper end portion for restricting the descending area of the film member-horizontally holding member, and the upper end portion can be held by the upper heating plate. In this case, the length of the shaft portion is set at least such that when the heat-resistant and stretchable film member contacts the upper face of the workpiece, the upper end of the film member-horizontally holding member is engaged with the lower face of the upper heating plate or the soaking plate thereunder. This enables the heat-resistant and stretchable film member to be pressed on the upper face of the workpiece closely in a fixed located fashion on press working. Moreover, it is possible that the upper end portion of the film member-horizontally holding member is vertically slidably guided, and fixed in the horizontal directions.

As another embodiment of the film member-horizontally holding member, a lattice-shaped rigid structural body not laterally bent may be directly or indirectly attached to the inner face of the heat-resistant and stretchable film member, corresponding to the pressing face thereof. In this case, such a construction is preferably employed, which enables the lattice-shaped structural body to push the heat-resistant and stretchable film member closely on the upper face of the workpiece in a located manner at least when the film member is brought into contact with workpiece. The film member-horizontally holding member can be integrally formed with the heat-resistant and stretchable film member when the latter is formed, or can be integrally formed by insert molding or screwing a hard resin or a metal fitting relative to the film member, for example. Furthermore, when the film member-horizontally holding member is integrally formed, the film member-horizontally holding member can vertically expand and contract, without being fixed, by arranging a vertically expandable and contractable spring therefor.

### (8) Driving Unit

The driving unit relatively moves the lower mold member and the upper frame member to contact the bottom face of the lower end portion of the upper frame member with the upper face of the upper end portion of the lower frame member. In that case, the lower face of the heat-resistant and stretchable film member is brought into contact with the upper face of the workpiece on the lower mold member in the state that the film member is substantially horizontally held while being prevented from hanging down. The lower heating plate, the lower frame member and the lower mold member may be vertically moved, or the upper heating plate, the upper frame member and the heat-resistant and stretchable film member containing the heat medium may be vertically moved.

In the former case, when the lower heating plate, the lower frame member and the lower mold member are vertically moved by means of a mechanism such as a cylinder and cylinder rod or the like, the bottom face of the lower end portion of the upper frame member is contacted with or spaced from the upper face of the upper end portion of the lower frame member. In the latter case, the upper press plate is fixed at the upper portions of the supporting poles, an intermediate movable plate is provided slidably to the supporting poles under the upper press plate, the upper heating plate is adiabatically fixed directly or indirectly to the lower face of the intermediate movable plate, a moving cylinder is provided above the upper press plate, a lower end portion of a cylinder rod of the moving cylinder is fixed to the intermediate movable plate through the upper press plate, and the bottom face of the lower end portion of the upper frame member is contacted with or spaced from the upper face of the upper end portion of the lower frame member by vertically moving the upper frame member.

As a method for preheating the workpiece with the upper and lower heating plates and applying a pressure to the heat medium inside the heat medium-filling space, it can be that either the upper frame member or the lower frame member not vertically moved is supported by a spring or springs, and the lower frame member or the upper frame member positively moved is further moved against the spring(s), after the above contacting, in the state that the heat medium-filling space is closed, so that the heat medium is pressurized inside the heat medium-filling space, while the heat-resistant and stretchable film member is being prevented from expanding radially outwardly at the outer periphery. Alternatively, the pressure may be applied by feeding the heat medium from the outside through the heat medium passage in place of or in addition to the spring construction. In any of the above methods, the workpiece is subjected to a predetermined hot press working with the heat-resistant and stretchable film member by applying the pressure upon the heat medium inside the heat medium-filling space, while the film member is prevented from expanding radially outwardly at the outer periphery. The hot press working includes a flat working for the thin plate-like workpiece, covering a thin element fixed on a package substrate with the workpiece as a protective sheet, an embossing working for the workpiece, curved face-forming for the workpiece along an upper face of a substrate, etc.

### Explanation of Specific Embodiments

In the following, specific embodiments of the present invention will be explained along with the attached drawings. Such embodiments are merely illustrative of the invention, and it goes without saying that the present invention is not limited to the illustrated embodiments.

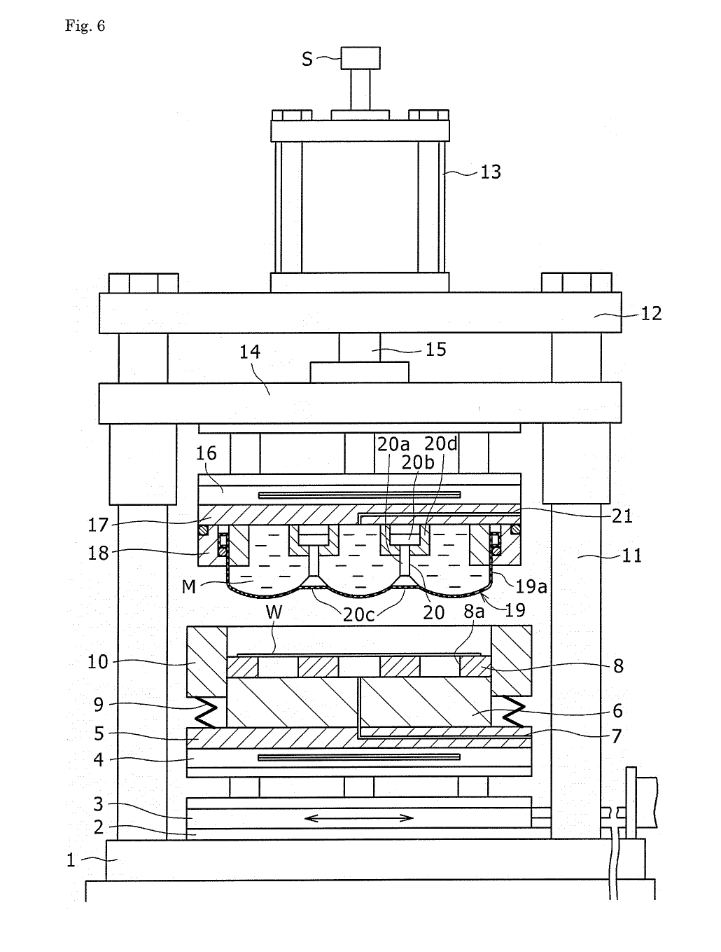

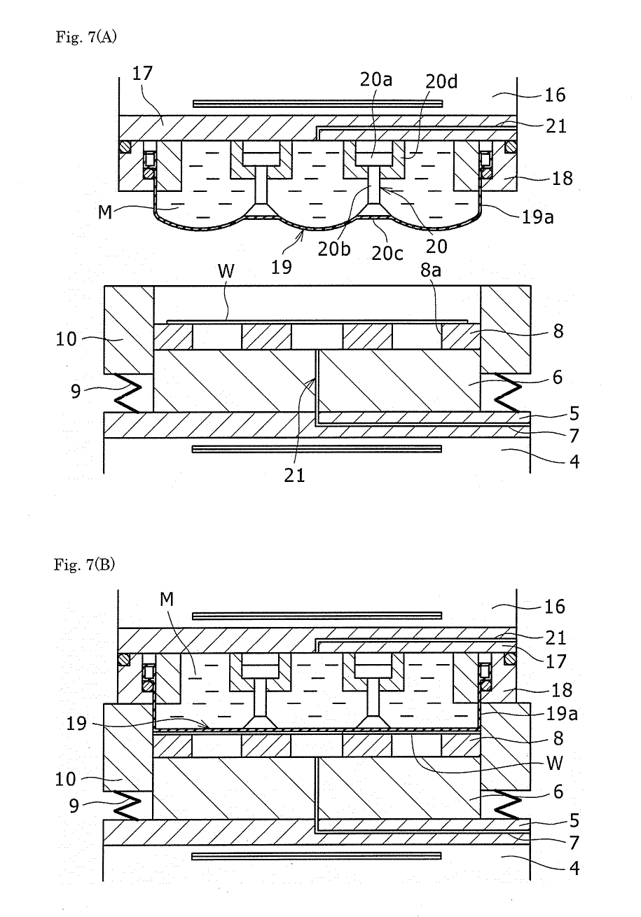

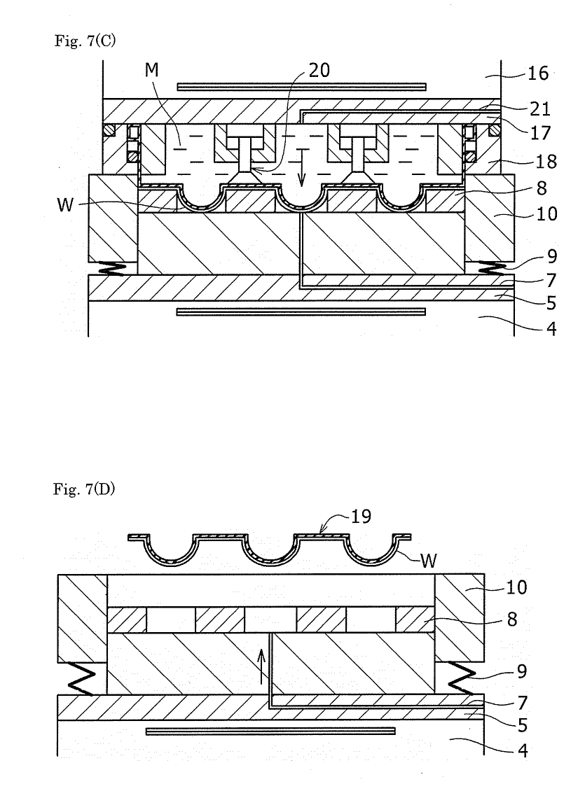

FIGS. 6 and 7 illustrate one embodiment of the hot press apparatus according to the present invention. In FIG. 6, a rail 2 is provided on an upper face of a base 1, a slide table 3 is arranged laterally movably on the rail 2, and a lower heating plate 4 is placed on the slide table 3 via posts and an adiabatic plate. Soaking plates 5 and 6 are arranged on the lower heating plate 4 as shown, an air ejecting path 7 is provided in the soaking plates 5 and 6 as shown, and a workpiece W is peeled from a lower mold member 8 after the press working by ejecting a high-pressure compressed air through the air ejecting path 7, and is then taken outside. In this embodiment, the lower mold member 8 is an exchangeable member which is provided with depression-forming through holes 8a. A lower frame member 10 is arranged on the upper face of the soaking plate 5 via a spring 9, and the lower frame member 10 is slidably fitted around outer peripheral faces of the soaking plate 6 and the lower mold member 8. The sectional shapes of the soaking plate 6 and the lower mold member 8 can be square, round or the like, and the sectional shape of the lower frame member 10 can be square or annular corresponding thereto.

Supporting poles 11 are erected on the base 1 at four corners, and an upper press plate 12 is fixed to the upper end portions of the supporting poles 11 with nuts. An air cylinder 13 is fixed to the upper face of the upper press plate 12. An intermediate movable plate 14 is held slidably relative to the supporting poles 11 under the upper press plate 12, and a lower end portion of a cylinder rod 15 of the air cylinder 13 is fixed to the upper face of the intermediate movable plate 14 so that the intermediate movable plate 14 may be vertically moved by the air cylinder 13. A reference sign S above the cylinder 13 denotes a stopper for restraining the descending area of the cylinder rod. An upper heating plate 16 is fixed to the lower face of the intermediate movable plate 14 via a fitting plate, a heat-emitting posts and an adiabatic plate. An upper frame member 18 is fixed to the lower face of the upper heating plate 16 via a soaking plate 17. As shown, the upper frame member 18 is liquid-tight to the soaking plate 17 by means of an O ring.

The upper frame member 18 is provided with a heat-resistant and stretchable film member 19. The outer peripheral portion of the heat-resistant and stretchable film member 19 is received liquid-tightly inside the upper frame member 18 by means of an O ring, and the outer peripheral portion of the film member 19 is shaped in the form of a reinforcing portion 19a. Film member-horizontally holding members 20 are attached to the film member 19. The film member-horizontally holding member 20 comprises a shaft portion 20a, an upper end portion 20b, a lower end portion 20c and a fixing portion 20d to receive an upper portion of the shaft portion 20a and the upper end portion 20b, and the lower end portion 20c is fixed to the inner face of the film member 19. Since the film member-horizontally holding member 20 is vertically movable by the above construction, passing through a substantially fixed area as viewed in a plane direction, and the heat-resistant and stretchable film member is supported in the fixed position as viewed in the plane direction, so that the film member can be located and held, while preventing a positional deviation of the workpiece. The film member-horizontally holding members 20 are provided in two rows. The film member-horizontally holding members is not limited to two rows but they may be in three or more rows. Plural film member-horizontally holding members 20 may be provided in each row of the holding members, or lower end portions 20c of the plural film member-horizontally holding members 20 arrayed in each row may be continuously provided.

A heat medium feeding passage 21 is provided in the soaking plate 17 such that its one end is opened to the lower face of the soaking plate, and a heat medium M is filled in the space defined by the soaking plate 17, the upper frame member 18 and the heat-resistant and stretchable film member 19. Fitted to the other end of the heat medium feeding passage 21 are a heat medium storage container and a heat medium feeding cylinder (both not shown). In this embodiment, when the bottom face of the lower end portion of the upper frame member 18 is contacted with the upper face of the upper end of the lower frame member 10 by descending the upper frame member 18, the reinforcing portion 19a at the outer periphery of the heat-resistant and stretchable film member 19 slides along the inner peripheral face of the lower frame member 10, so that the heat-resistant and stretchable film member 19 is prevented from expanding radially outwardly at the outer periphery during the press working.

Next, the operation of the hot press apparatus of the first embodiment according to the present invention will be explained with reference to FIGS. 7(A) to 7(D). First, the air cylinder 13 is operated from a raised position shown in FIG. 7(A) to descend the intermediate movable plate 14 (See FIG. 6), the upper heating plate 16, the soaking plate 17, the upper frame member 18 and the heat-resistant and stretchable film member 19. As shown in FIG. 7(B), the bottom face of the lower end portion of the upper frame member 18 is contacted with the upper face of the upper end portion of the lower frame member 10. The reinforcing portion 19a at the outer peripheral portion of the heat-resistant and stretchable film member 19 is slid along the inner peripheral face of the lower frame member 10, and the heat-resistant and stretchable film member 19 is brought into contact with the upper face of the workpiece, so that the workpiece W is held between the lower mold member 8 and the heat-resistant and stretchable film member 19. When an operation valve of the cylinder is stopped on the way at this position, the cylinder rod 15 temporarily stops descending. Then, the workpiece W is preheated with the heat medium M heated. At that time, the lower end portions 20c contact the workpiece W via the film member at positions other than those to be worked.

As shown in FIG. 7(C), when the upper frame member 18 is descended by the air cylinder 13 in the state that the heat medium feeding passage is closed, the lower frame member 10 is pushed down through shrinking the spring 9. On the other hand, the upper portion of the shaft portion 20a and the upper end portion 20b of the film member-horizontally holding member 20 slid upwardly along the fixing portion 20d, and descending of the cylinder rod 15 is stopped by the stopper S (FIG. 6). Therefore, the descending area of the cylinder rod 15 of the cylinder 13 can be limited by adjusting the stroke of the stopper S. At this time, it can be that the upper face of the upper end portion 20b of the film member-horizontally holding member 20 is fixedly contacted with the lower face of the soaking plate 17, and those portions of the heat-resistant and stretchable film member which are not worked are pressed with the lower end portions 20c of the film member-horizontally holding member 20. As mentioned above, depressions are formed for the workpiece W with the heat-resistant and stretchable film member until the descending of the air cylinder 13 is stopped by the stopper S. Although the press working operation is stopped on the way by the provision of the stopper S in this embodiment, the descending area of the air cylinder needs not be restrained by the stopper S in the case that the workpiece is subjected to forming along with the upper face of the lower mold member corresponding to the depressions.

After the workpiece W is hot pressed, the upper frame member 18 and the heat-resistant and stretchable film member 19 are moved upwardly by actuating the air cylinder 13, and the hot pressed product is peeled from the lower mold member 8 by ejecting a high-pressure air through the air ejecting passage 7. Then, the slide table 3 is laterally moved along the rail 2, the lower heating plate 4, the soaking plates 5 and 6, the lower mold member 8, the lower frame member 10, etc. are moved out of the hot press apparatus, and the hot pressed workpiece is taken out. Thereafter, a fresh workpiece W is placed on the upper face of the lower mold member 8, the lower heating plate 4, the soaking plates 5 and 6, the lower mold member 8, the lower frame member 10, etc. are moved into the hot press apparatus by the slide table 3, followed by a succeeding hot press step.

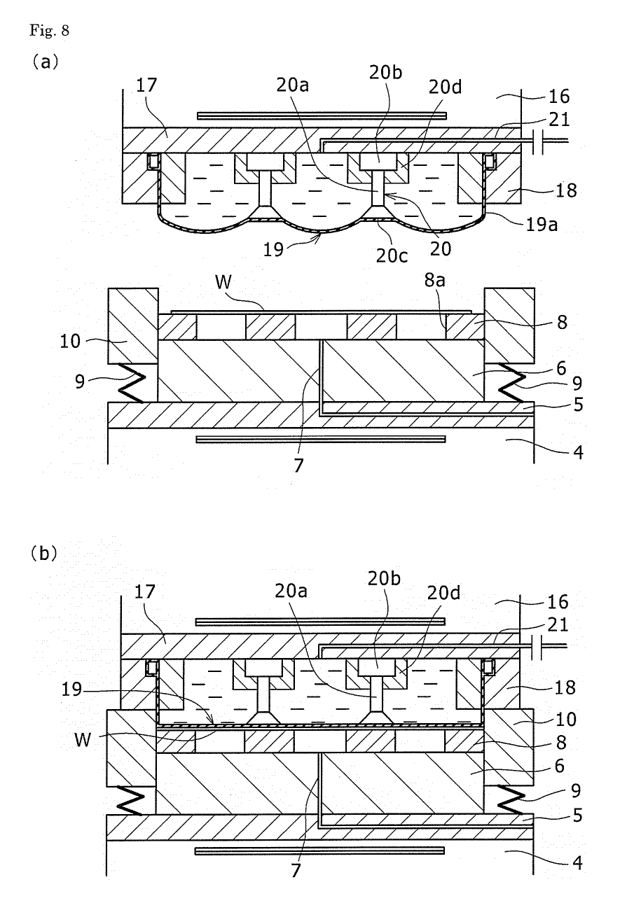

A second embodiment of the hot press apparatus according to the present invention is illustrated in FIGS. 8(a) and 8(b). The first and second embodiments are different in that in the second embodiment, an upper portion of a shaft portion 20a and an upper end portion 20b of the film member-horizontally holding member 20 are fixed to a fixing portion 20d. Therefore, the film member-horizontally holding members 20 are always in fixed position, and support the heat-resistant and stretchable film member at a fixed position.

The air cylinder 13 is operated from a raised position shown in FIG. 8(a), and an intermediate movable plate 14 (See FIG. 6), an upper heating plate 16, a soaking plate 17, an upper frame member 18 and a heat-resistant and stretchable film member 19 are descended. As shown in FIG. 8(b), the bottom face of a lower end portion of the upper frame member 18 is contacted with the upper face of an upper end portion of the lower frame member 10, a reinforcing portion 19a at the outer periphery of a heat-resistant and stretchable film member 19 is slidably contacted with the inner peripheral face of the lower frame member 10, and a workpiece W is held between the lower frame member 8 and the heat-resistant and stretchable film member 19.

At this position, the lower end portions 20c of the film member-horizontally holding members 20 contact and press the workpiece W via the heat-resistant and stretchable film member 19, and fixes the film member 19 to the lower mold member 8. Since the upper end portions 20b of the film member-horizontally holding members 20 are fixed to the soaking plate 17, the distance between the soaking plate 17 and the lower mold member 8 is constant. Thereafter, the workpiece W is heated with the heated heat medium M, the upper frame member 18 is advanced against the spring 9 by the air cylinder 13 in the state that the heat medium feeding passage is opened, the lower frame member 10 is pushed down, and depressions are formed for the workpiece W with the heat medium inside the heat medium-filling space via the heat-resistant and stretchable film member by applying a pressure to the heat medium inside the heat medium-filling space, while the film member is prevented from expanding radially outwardly at the outer periphery.

FIGS. 9(A) to 9(D) illustrate a third embodiment of the hot press apparatus according to the present invention. This embodiment is suitable for a case where a workpiece W is bonded onto a substrate A having a curved upper face (in this embodiment, an upper-face peripheral portion is curved) and made of an acrylic resin or the like. The same constituting parts as in the above-mentioned embodiments are provided with the same reference numerals, and explanation thereof is omitted. In this embodiment, a depression 6a is formed at an upper face of a soaking plate 6, and a forming jig J is held above the soaking plate 6 via a spring SP arranged in the depression 6a. The jig J comprises a peripheral plane-like portion J1 and a central projecting portion J2, and a central portion of the central projecting portion J2 is provided with a square-section through hole J3 for receiving the substrate A. Upper faces of J1 and J2 are substantial horizontal. When the bottom face of the substrate A is arranged on the upper face of the soaking plate 6 and fitted in the through hole J3 of the jig J, the upper face of the substrate A is positioned slightly lower than the upper face of the central projecting portion J2 of the jig, and the workpiece W is located and arranged in the depression defined by the upper face of the substrate A and the through hole J3 of the jig (See FIG. 9(A)).

The intermediate plate 14 (See FIG. 6), the upper heating plate 16, the soaking plate 17, the upper frame member 18 and the heat-resistant and stretchable film member 19 are descended by actuating the air cylinder from a raised position shown in FIG. 9(A), and as shown in FIG. 9(B), the bottom face of the lower end portion of the upper frame member 18 is contacted with the upper face of the upper end portion of the lower frame member 10, and the reinforcing portion 19a at the outer periphery of the heat-resistant and stretchable film member 19 is slidably contacted with the inner peripheral face of the lower frame member 10. The lower end portions 20c of the film member-horizontally holding members 20 are contacted with the upper face of the central projecting portion J2 via the film member 19, and meanwhile the workpiece W is held between the substrate A and the heat-resistant and stretchable film member 19.

Thereafter, the workpiece W is preheated with the heated heat medium M, and the jig J is pushed down against the spring SP by actuating the air cylinder as shown in FIG. 9(C), so that the workpiece W is successively bonded onto the curved upper face of the substrate A. After the bonding, the air cylinder is actuated in the reverse direction, and the substrate A with the bonded workpiece is taken out by feeding the compressed air through the air ejecting passage 7. See FIG. 9(D). For example, the present embodiment can be applied to cases where thin plate-like workpieces such as a flexible printed circuit board, a bendable organic EL panel, a touch panel, etc. are bonded onto molded bodies having curved upper faces under a uniform pressure without causing a positional deviation.

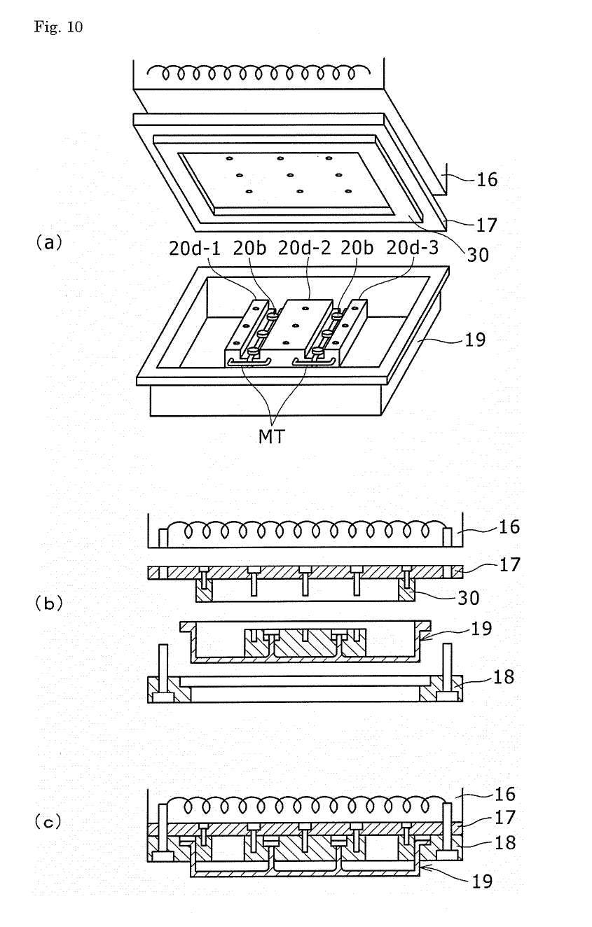

FIGS. 10(a) to 10(c) illustrate a construction in which a heat-resistant and stretchable film member 19 is held by film member-horizontally holding members 20. The film member-horizontally holding members 20 are provided in two rows, and three film member-horizontally holding members 20 are arranged in each row. Lower end portions 20c of the film member-horizontally holding members 20 in each row are continued to form a single row. As shown in FIG. 10(a), a film-fixing portion 30 is fixed to a lower face of a soaking plate 17, and on the other hand, the film member-horizontally holding members 20 erected on the inner face of the heat-resistant and stretchable film member 19 are sandwiched between horizontal holding member-fixing members 20d-1, 20d-2 and 20d-3 (having an L-letter sectional shape, a projecting sectional shape and a reverse L-letter shape), and the sandwiched state is held by connecting fittings MT.

Next, an upper end portion of the heat-resistant and stretchable film member 19 is contacted with the lower face of the soaking plate along the outer periphery of the film-fixing portion 30. The soaking plate 17 is fixed to the horizontal holding member-fixing members 20d-1, 20d-2 and 20d-3 by screws, the outer periphery of the upper end portion of the heat-resistant and stretchable film member 19 is held between the soaking plate 17 and the upper frame member 18 by engaging the upper frame member 18 with the outer periphery of the film member, and the upper frame 18 is fixed to the soaking plate 17 and the upper heating plate 16 by screws. Thereby, the heat-resistant and stretchable film member is vertically slidably held by the film member-horizontally holding members 20.

FIGS. 11(a) and 11(b) illustrate other embodiment in which three rows of film member-horizontally holding members 20 are provided inside a vessel-shaped heat-resistant and stretchable film member 19 and three film member-horizontally holding members 20 are arranged spaced in each row. FIG. 11(a) is a perspective view in which the film member-horizontally holding members 20 are provided inside the vessel-shaped heat-resistant and stretchable film member 19 and FIG. 11(b) is a sectional view as cut and viewed along a line A-A. In the figures, a reference numerals 19a denotes a reinforcing rib. Although not shown in detail, a lower end portion of the film member-horizontally holding member 20 is designed in the form of a nut, which is fixedly buried in an inner face of a film member during the formation thereof, and a lower end portion of a shaft portion with a head portion at an upper end portion is fixedly screwed into the nut.

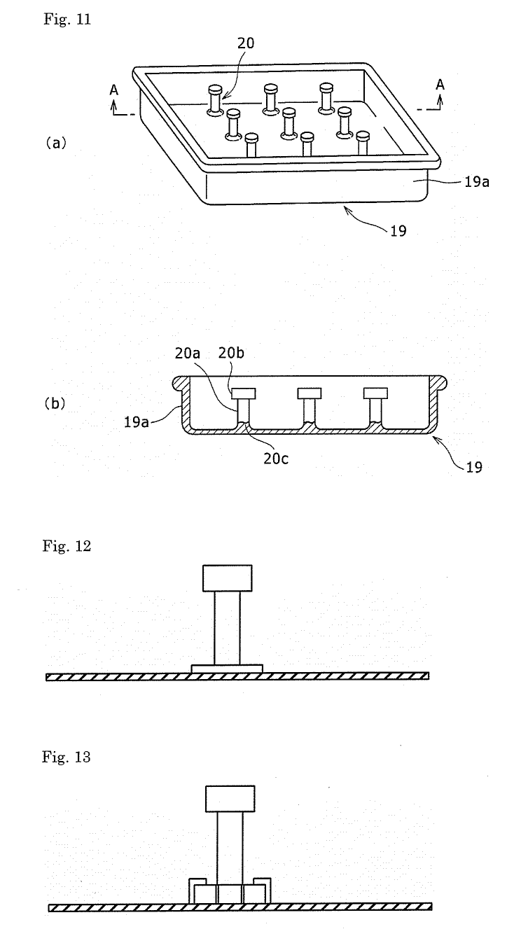

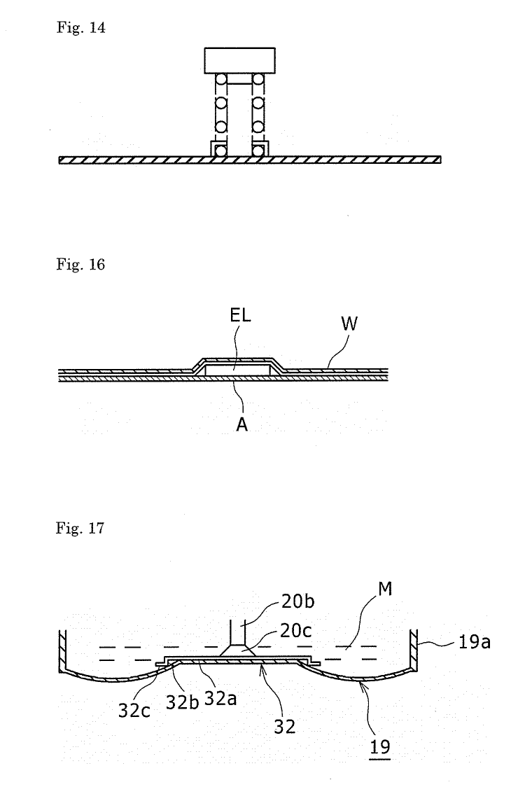

FIGS. 12, 13 and 14 illustrate other embodiments of film member-horizontally holding members. FIG. 12 shows the embodiment in which the film member-horizontally holding member is made of a hard resin or a metal fitting and its lower end is fixed to the film member. FIG. 13 shows the embodiment in which the film member-horizontally holding member is made of a hard resin or a metal fitting, a nut at its lower end portion is insert molded in the film member and a bolt is screwed into this nut. FIG. 14 shows the embodiment in which a lower end portion of a spring is insert molded into a film member and a lid is caulked to its upper end portion. When the caulked lid at the upper end portion is fixed and the heat medium is fed inside the heat-resistant and stretchable film member, the film member horizontal holding means is expanded.

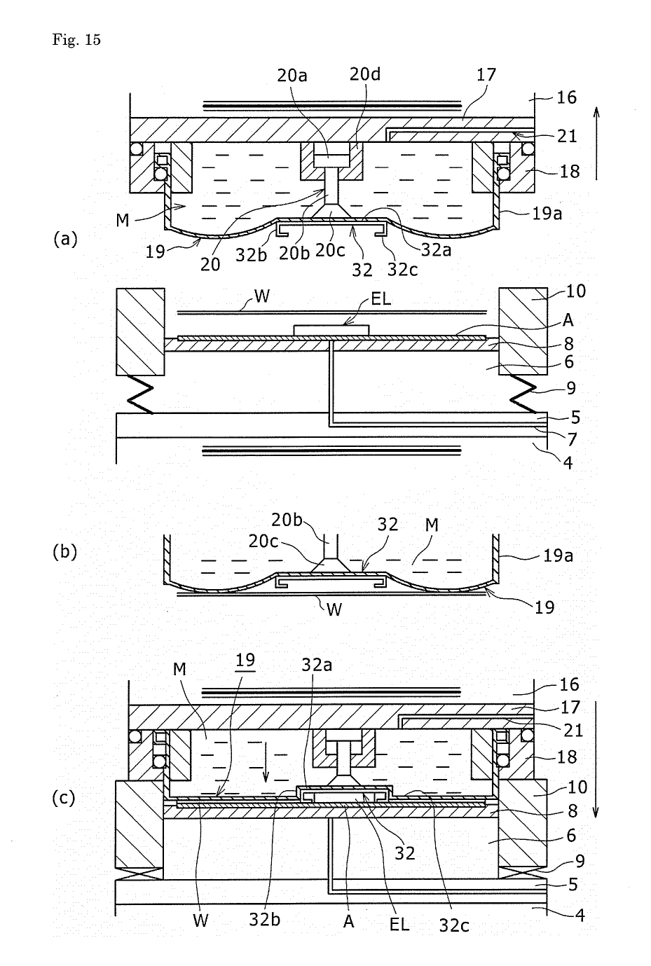

FIGS. 15(a) to (c) schematically show a still further embodiment of the hot press apparatus for a thin plate-like workpiece according to the present invention. The same or similar constituting parts as in the above-mentioned embodiments are provided with the same or similar reference numerals, and their explanation is omitted. In the present embodiment, a protective cover 32 is integrated onto a central lower face of a heat-resistant and stretchable film member 19, and a lower end portion 20c of a film member-horizontally holding member 20 is fixed to an upper face of the protective cover 32 via the film member-horizontally holding member 20. An upper end portion 20a and an upper portion of a shaft portion 20b of the film member-horizontally holding member 20 are slidably held in a fixing portion 20d. Thereby, the protective cover 32 is substantially horizontally held by the film member-horizontally holding member 20, while a position where the protective cover is held is kept constant as viewed in a horizontal direction.

As shown in FIG. 15(a) and FIG. 15(c), an element EL, such as a semiconductor element, having a rectangular parallelepiped shape or a cylindrical shape is placed on an substrate A. The protective cover 32 comprises an upper flat face portion 32a, a peripheral portion 32b extending downwardly from an outer peripheral edge portion of the upper flat face portion 32a and a press portion 32c extending radially inwardly from a lower end portion of the peripheral portion 32b. The protective cover protects the element EL so that the hot press pressure may not be applied to the element directly through the heat-resistant and stretchable film member. FIG. 15(b) shows a state in which the heat-resistant and stretchable film member 19 is brought into contact with the workpiece W arranged above the substrate A. As shown in FIG. 15(b), when the lower face of the heat-resistant and stretchable film member 19 is brought into contact with the upper face of the sheet-like workpiece W placed on the upper face of the element EL on the substrate A on the way in which the upper frame member 10 is descended, the descending of the upper frame member is temporarily stopped and the sheet-like workpiece is softened by preheating. At this time, the protective cover 32 is positioned above the element EL on the upper face of the substrate A via the workpiece W. After the preheating, the upper member is further descended, and the workpiece is hot pressed and bonded onto the upper faces of the substrate A and the element EL. Thereby, the element EL is sealed on the substrate A with the sheet-like workpiece.

At this time, the workpiece W is pressed onto the substrate by the press portion 32c of the protective cover 32 at a position outwardly around the element. The peripheral portion 32b surrounds the outer periphery of the element, and the lower face of the upper flat face portion 32a contacts the upper face of the element EL via the workpiece W. Thus, a portion of the workpiece W is hot pressed on the upper face of the element EL via the protective cover, and almost the remaining portion of the workpiece W is hot pressed on the substrate A with the film member outside the protective cover. As shown in FIG. 15(c), the element EL and the substrate A is protected with the workpiece W worked in a trapezoidal sectional shape.

FIG. 16 schematically shows a section of a hot pressed product obtained by the above hot pressing. FIG. 17 shows a still further embodiment in which a protective cover 32 is integrally attached to a central inner face of a heat-resistant and stretchable film member 19. In this embodiment, the protective cover comprises an upper flat portion 32a, a peripheral portion 32b extending downwardly from an outer peripheral edge portion of the upper flat face portion 32a, and a press portion 32c extending radially outwardly from a lower end portion of the peripheral portion 32b.

Since the present embodiment is the same as that in FIGS. 15(a) to (c) except that the press portion 32c extends radially outwardly from the lower end portion of the peripheral portion 32b, explanation thereof is omitted.

### INDUSTRIAL APPLICABILITY

The hot press apparatus and the hot press method for thin plate-like workpieces according to the present invention can be used for the following applications, and have extremely high industrially applicable values.
1. Lamination and bonding of printed circuit boards without causing laminating deviations
2. Bonding shield films onto rigid flexible substrates having uneven surface shapes
3. Bonding sealing films onto element-housing substrates, package substrates and the like having uneven surface shapes, curved surface shapes, etc.
4. Embossing necessary portions such as non-printed portions of printed film workpieces, forming automobile speed panels having printed speed gauges while preventing deviation in printed positions
5. Forming package containers requiring accuracy in positions for taking out semiconductors, etc. (Precise three-dimensional forming)
6. Producing shrinkage a bendable printed circuit board by bonding a sheet substrate laminate made of two or more copper clad laminate sheets, while forming a groove thereon
7. Bonding thin plate-like workpieces such as flexible printed circuit boards, bendable organic EL panels, touch panels and the like onto upper face-curved molded bodies such as cell phone bodies

What is claimed is:

1. A hot press apparatus for hot pressing a thin plate-like workpiece, comprising:
(1) a base,
(2) a lower heating plate adiabatically placed on an upper face of the base,
(3) a lower mold member arranged on an upper face of the lower heating plate and having a flat and horizontal upper face,
(4) a lower frame member erected on the base and surrounding the lower mold member,
(5) a taking-out unit for taking out the workpiece placed on the upper face of the lower mold member,
(6) supporting poles erected on the base,
(7) an upper press plate fixed at upper portions of the supporting poles,
(8) an upper heating plate adiabatically arranged under a lower face of the upper pressing plate,
(9) an upper frame member arranged on a lower face of the upper heating plate and having a bottom face of a lower end portion thereof to be brought into contact with an upper face of an upper end portion of the lower frame member,
(10) a heat-resistant and stretchable film member stretched at and covering the lower end portion of the upper frame member,
(11) a heat medium filled in a heat medium-filling space defined by the upper heating plate, the upper frame member and the heat-resistant and stretchable film member,
(12) a heat medium passage adapted to feed and discharge the heat medium for the heat medium-filling space,
(13) a film member-horizontally holding member adapted to substantially horizontally hold the heat-resistant and stretchable film member while preventing the film member from hanging, said film member-horizontally holding member being fitted to keep the film member at a substantially constant position as viewed in a horizontal direction, and
(14) a driving unit for relatively moving the lower mold member and the upper frame member and bringing the bottom face of the lower end portion of the upper frame member into contact with the upper face of the upper end portion of the lower frame member and spacing the former from the latter,
(15) wherein the bottom face of the lower end portion of the upper frame member is brought into contact with the upper face of the upper end portion of the lower frame member by relatively moving the lower mold member and the upper frame member, the lower face of the heat-resistant and stretchable film member is brought into contact with the upper face of the workpiece on the lower mold member in the state that the heat-resistant and stretchable film member is held substantially horizontally while being prevented from hanging, the workpiece is preheated with the upper and lower heating plates, the workpiece is subjected to a predetermined hot press working with the heat resistant and stretchable film member by applying a pressure to the heat medium inside the heat medium-filling space while the film member being prevented from expanding radially outwardly at an outer periphery thereof.

2. The hot press apparatus for hot pressing a thin plate-like workpiece as set forth in claim 1, wherein the lower mold member is provided with an upper face-opened depression or a through hole at such a position as not opposed to the film member-horizontally holding member, a depression is formed for the workpiece with the heat-resistant and stretchable film member by applying the pressure to the heat medium.

3. The hot press apparatus for hot pressing a thin plate-like workpiece as set forth in claim 1, wherein the film member-horizontally holding member comprises a lower end portion attached to the heat-resistant and stretchable film member, a shaft portion extending upwardly from the lower end portion and an upper end portion upwardly extending from the shaft portion, and the upper portion is held by the upper heating plate.

4. The hot press apparatus for hot pressing a thin plate-like workpiece as set forth in claim 1, wherein a spring is provided under a lower end portion of the lower frame member or above an upper end portion of the upper frame member to mitigate an impact when the upper face of the upper end portion of the lower frame member is brought into contact with the bottom face of the lower end portion of the upper frame member.

5. The hot press apparatus for hot pressing a thin plate-like workpiece as set forth in claim 1, wherein the film member-horizontally holding member comprises a lower end portion attached to the heat-resistant and stretchable film member, a shaft portion extending upwardly from the lower end portion and an upper end portion extending upwardly from the shaft portion, the shaft portion and/or the upper end portion of the film member-horizontally holding member is horizontally fixed and held in a receiving portion slidably in vertical directions, and a spring is provided under the lower end portion of the lower frame member or above the upper end portion of the upper frame member, so that an impact is mitigated when the upper face of the upper end portion of the lower frame member is brought into contact with the bottom face of the lower end portion of the upper frame member, and the workpiece is subjected to the predetermined hot pressing by further moving the upper frame member in the direction of the lower frame member or the lower frame member in the direction of the upper frame member against the spring in the state that the heat medium passage is closed.

6. The hot press apparatus for hot pressing a thin plate-like workpiece as set forth in claim 1, wherein film member-horizontally holding members are provided in plural rows, the plural film member-horizontally holding members are arranged spaced in each row, lower end portions of the plural membrane horizontal holding members arranged spaced in each of the rows are discontinuous or continuous to form a single row.

7. The hot press apparatus for hot pressing a thin plate-like workpiece as set forth in claim 1, wherein the heat-resistant and stretchable film member projects downwardly from the bottom face of the lower end portion of the upper frame member, an inner peripheral face of the lower frame member is slidable around an outer peripheral face of the lower mold member, and when the bottom face of the lower end portion of the upper frame member is brought into contact with the upper face of the upper end portion of the lower frame member by relatively moving the lower mold member and the upper frame member, an outer peripheral face of the heat-resistant and stretchable film member contacts the inner peripheral face of the lower frame member to prevent the film member from expanding radially outwardly.

8. The hot press apparatus for hot pressing a thin plate-like workpiece as set forth in claim 1, wherein the lower frame member is placed on the base via a spring, an intermediate moving plate is provided slidably to the supporting poles under the upper press plate, the upper heating plate is adiabatically fixed to a lower face of the intermediate moving plate, a moving cylinder is provided above the upper press plate, and a lower end portion of a cylinder rod of the moving cylinder is fixed to the intermediate moving plate through the upper press plate.

9. The hot press apparatus for hot pressing a thin plate-like workpiece as set forth in claim 1, wherein a part of the heat-resistant and stretchable film member is constituted by a protective cover, a lower end portion of the film member-horizontally holding member is attached to the protective cover; the protective cover is held by the film member-horizontally holding member substantially horizontally such that a position where the protective cover is held is substantially constant as viewed in a horizontal direction; when the workpiece is to be hot pressed, the workpiece is protected with the protective cover such that a hot press is not applied to the workpiece directly through the heat-resistant and stretchable film member at a portion of the workpiece corresponding to the protective cover, whereas the workpiece is hot pressed through the heat-resistant and stretchable film member at the other portion.

10. The hot press apparatus for hot pressing a thin plate-like workpiece as set forth in claim 9, wherein the workpiece is placed on a substrate having a projected portion at an upper face thereof, and the protective cover is configured to surround the projected portion; when the workpiece is to be hot pressed, a central lower face of the protective cover contacts an upper face of the projected portion through the workpiece, and the workpiece is hot pressed onto the substrate through the protective cover at the upper face of the projected portion and through the heat-resistant and stretchable film member at the other portion.

11. The hot press apparatus for hot pressing a thin plate-like workpiece as set forth in claim 10, wherein the protective cover comprises an upper flat portion, a peripheral portion extending downwardly from an outer edge portion thereof, and a press portion at a lower end of the peripheral portion.

12. The hot press apparatus for hot pressing a thin plate-like workpiece as set forth in claim 1, wherein a slide table is arranged laterally movably on an upper face of the base, the lower heating plate is arranged on the slide table, the slide table is moved into or out of the hot press apparatus by a slide table-moving unit, so that the lower heating plate, the lower frame member and the lower mold member are moved into or out of the hot press apparatus to take out the hot pressed workpiece, and after a fresh workpiece is fitted onto the lower mold member, the fresh workpiece is arranged inside the hot press apparatus.

13. A hot press method for hot pressing a thin plate-like workpiece, comprising
(1) placing a thin plate-like workpiece on that upper face of a lower mold member which is flat and horizontal,
(2) arranging a heat medium-filling space having a heat-resistant and stretchable film member at a lower face such that a lower face of the heat-resistant and stretchable film member is substantially horizontally held at a substantially constant position as viewed horizontally, while a lower face of the heat-resistant and stretchable film member being prevented from hanging,
(3) filling a heat medium inside the heat medium-filling space,
(4) bringing the lower face of the heat-resistant and stretchable film member into contact with an upper face of the workpiece on the lower mold member in the state that the heat-resistant and stretchable film member is kept substantially horizontal, while being prevented from hanging down,
(5) preheating the workpiece, and
(6) subjecting the workpiece to a predetermined hot pressing with the heat-resistant and stretchable film member by applying a pressure to the heat medium inside the heat medium-filled space, while the heat-resistant and stretchable film member is prevented from expanding radially outwardly at an outer peripheral portion thereof.
